(19) United States
(12) Patent Application Publication
(10) Pub. No.: US 2016/0119300 A1
(43) Pub. Date: Apr. 28, 2016

(54) METHOD FOR THE ADMINISTRATION OF MEDIA FOR WIRELESS COMMUNICATION

(71) Applicant: KABA AG, Wetzikon (CH)

(72) Inventors: Paul STUDERUS, Oberweningen (CH); André LUSCHER, Feldmeilen (CH); Andreas HABERLI, Bubikon (CH)

(21) Appl. No.: 14/894,157

(22) PCT Filed: May 26, 2014
(86) PCT No.: PCT/CH2014/000071

§ 371 Date: Dec. 28, 2015

(30) Foreign Application Priority Data
May 29, 2013 (CH) 1026/13

(51) Int. Cl. H04L 29/06; H04W 12/04

(52) U.S. Cl. CPC H04L 63/0492; H04L 63/061; H04W 12/04

(57) ABSTRACT

A method is provided for carrying out a reading and/or writing process, using a first actively operated medium, from or on a passively operated second medium wherein the first medium has a secured environment. The method includes providing a reading and/or writing applet in the secured environment, providing an application outside of the secured environment, transmitting a reading and/or writing command to the applet using the application, converting the reading and/or writing command into a reading and/or writing signal using the applet, and transmitting the reading and/or writing signal to the passively operated second medium.

### BACKGROUND OF THE INVENTION

1. Field of the Invention

The present invention relates to methods and devices in the field of wireless communication, in particular of near field communication (NFC). NFC is thereby an abbreviation of the term near field communication and defines an international transmission standard for the contact-free exchange of data over short distances of up to 10 cm and with a data transmission rate of maximal 424 kBit/s. The present invention also relates to other standards of short-range wireless communication, which is to say Bluetooth, millimetre wave gigabit wireless (wireless GIGE), wireless LAN, wireless USB, infrared, etc.

2. Description of Related Art

NFC communication connections are standardised, short-range connections that are widely and comprehensively applied in the state of the art. NFC communication connections, for example, have been suggested or are already used for checking an access authorisation, for instance for ski tickets/passes on ski lift access installations, for motor vehicle keys and the respective motor vehicle, for hotel room keys and hotel rooms, or with employee passes at doors and/or at working-time recording installations. NFC systems, however, are also of interest concerning the payment of small amounts at corresponding payment installations and for data transmission, such as of pictures from a first mobile telephone to a second mobile telephone.

A first aspect of the invention relates to service media (read devices or read and write devices (control modules) which, for example, are installed in locks for access control, or prepaid card debit devices, ticket control devices and/or invalidating devices) and their administration. It particularly relates to the case, in which such service media are not online and are connected directly to a trusted service manager (TSM) or another trustworthy authority, via a secure connection, as is often the case in access control and with simpler read devices or write and read devices, for example due to these being conceived as battery-operated stand-alone devices.

The first aspect specifically relates to a method for administrating a service medium by an administration authority, in particular a trusted service manager, TSM. This second medium, for example, can include a second SU (secure unit) that is to be administrated (managed). The second medium includes a communication module.

An SU—the subsequently discussed characteristics and definitions of the SU and of the TSM apply to all aspects of the invention—for example is a so-called secure environment (SE), and often the term secure element (SE) is to be found in literature. Secure environments (SEs) as chips with CPU and memory and with standardised security standards are obtainable for different applications.

An SE (in the context of “secure element”) has its own secure processor and its own secure memory. The secure memory of an SE can, for example, include different parts, for instance a working memory and a data memory. An SE is typically designed in the form of a security chip. Thereby, a security chip is to be understood as an integrated circuit, thus an electronic circuit on a substrate. A security chip, for example, is a monolithic semiconductor substrate with electronic elements and conductors. An SE can thereby in particular consist of several regions, which is to say parts of the security chip, which are arranged in a spatially separated manner but are functionally connected, in order to render an unauthorised read-out more difficult.

An SU can also be designed a so-called trusted zone, i.e. as a region of a chip (for example including at least one CPU core and memory), which functionally corresponds to an SE, as an alternative to a dedicated chip. The SU in this also includes secure processor means and secure memory means.

An SE or a trusted zone can be encompassed, for example, by a SIM card, be encompassed by a memory card (such as e.g. an SD card, microSD card or likewise) or be encompassed by other electronic apparatus, such as e.g. mobile telephones, watches, RFID cards, RFID read devices, keys with microchips, locks, automatic vending machines, payment terminals, portable electronic apparatus such as tablet computers and likewise.

An SE or a trusted zone can thereby fulfil demands placed upon the trustworthiness according to different known standards or demands of known security levels. An SE, for example, can include a so-called EAL (evaluation assurance level). These EALs exist in seven stages (from EAL1 to EAL7). The secure units for the different aspects of the invention, for example, correspond at least to EAL2, at least to EAL3 or at least EAL4.

An SU, for example, can however also include elements that at least partly are formed outside a dedicated chip of an SE—or of a trusted zone. An SU very generally can include secure processor means and its own secure memory. The secure memory of an SU includes different parts for example, for instance a working memory and a data memory. In particular, an SU can thereby consist of several elements, which are arranged in a spatially separated manner but which are functionally connected, in order to render an unauthorised read-out more difficult.

Solutions with virtualised, secure units are also possible (for example, within the framework of a “cloud” solution), wherein such a secure unit, which is not physically arranged in the medium, is unambiguously assigned to a medium and corresponds to the same specifications concerning security as are physically present in a monolithically integrated processor.

An SU is very generally to be understood as a functional unit, which is configured for a manipulation-safe and read-protected keeping and processing of data and thus functionally corresponds to a secure element according to NFC standards, for example GlobalPlatform specifications. An SU accordingly can be a functional unit that is capable of serving as a secure element according to NFC standards and/or as a subscriber identity module (SIM) of a mobile terminal device in a mobile telephone network.

In particular, for example, data that within the framework of an authentication process identifies the medium with the SU (e.g. user medium) compared to another medium (e.g. service medium) is stored in the SU.

A trusted service manager (TSM) is a device in near field communication systems (NFC systems), which is known per se. The TSM is capable of administrating, i.e. writing secure elements (or generally SUs). Firmware updates, key changes etc, can be carried out, for example.

TSMs mentioned in this text, for example, fulfil the preconditions according to the NFC standard.

A TSM is designed in a manner such that it is capable of a secure transfer of information into an SU. The transfer thereby is effected in a secure and manipulation-protected manner. It can be effected by contact or—the more often variant—free of physical contact between the TSM and the SU. A typical example of a TSM is a mobile network operator (MNO) that transfers data in a manner free of physical contact and in a secured manner to an SU in a mobile telephone by way of the mobile telephone network.

However, for this purpose, the mentioned direct, mostly contact-free connection to the respective medium with the SE is necessary, which is not necessarily the case in the cases discussed here.

A high expense therefore arises on maintenance, for maintaining service media—for example with an SU—which are not online, inasmuch as this maintenance is possible at all. In particular, updates of system parameters and/or software (in particular firmware) and repair are complicated, time-consuming and costly, since a trustworthy maintenance person with secure means which are specially configured for this must betake himself to such a service medium.

### SUMMARY OF THE INVENTION

It is therefore the object of the first aspect of the invention, to provide a method and a communication system of the initially mentioned type, which at least partly avoids a part of the disadvantages mentioned above.

The method according to the first aspect of the invention includes the following steps:
step 1: transmitting first administration information from an administration authority to a first SU encompassed by a first, mobile medium,
step 2: creating a communication connection between a first communications module encompassed by a first medium, and the second communication module,
step 3: transmitting second administration information, which is derived from the first administration information, from the first SU to the first communication module and via the communication connection to the second communication module.

Provided that the service medium includes a secure unit (here called “second SU”) and the parts of the service medium, which are to be maintained, are in the second SU, then the second administration information is finally transmitted to the second SU.

Thereby, the respective communication modules or parts thereof can be constituents of the respective SUs, or the communication modules can be separate.

The administration authority in particular can be a trusted service manager.

The communication connection, for example, is an NFC communication connection.

The second administration information is derived from the first administration information. For example, the first administration information includes the second administration information. In particular, the first and the second administration information can be identical. It is also possible for the second administration information to include the first administration information. In particular, the first administration information can include the second administration information as well as optionally additional information such as an identification of the second medium to be administrated for instance. Other types or derivation/processing of the first administration information into the second administration information are also conceivable.

The method can fulfil the tasks described above, since the second medium by transfer receives the second administration information from the administration authority (i.e. from the TSM in the example discussed here) via the first administration information and the first medium. The second medium therefore is administrated by the TSM without the second medium having to be connectable online to the TSM, thanks to the method described above.

The first medium in particular can be capable of peer-to-peer communication via NFC, and it can be a mobile apparatus or part of a mobile apparatus, in particular a mobile telephone.

Another communication connection can also serve for transferring first administration information from the administration authority to the first medium, for example Bluetooth, WLAN, infrared, etc., instead of peer-to-peer NFC. Complementarily or alternatively to this, the communication connection between the first and second medium can also be effected via a communication connection which is different to NFC, for example Bluetooth, WLAN, infrared, etc., provided that the second medium is configured for this.

The method thus also permits a second medium to be administrated (managed) with a simple construction and without an online communication possibility, via methods and protocols, as are known for the administration of SEs, for example in smart phones.

It is also advantageous, for example, that with each creation of an NFC communication connection between the second medium and any first medium, there exists the possibility of transferring the second administration information from the first medium to the second medium. Thus, the administration of the second SU by second media, for instance, can be combined with other interactions between the first and the second medium. The administration can be effected incidentally so to speak, when the opportunity arises.

The following example is described for an improved illustration: in a hotel, second media, which are designed as control modules of door locks, are to be provided with maintenance data which is of no significance concerning security (for example, an adaptation of a text to be displayed on a display) by way of a TSM. If the hotel for instance applies an emulated RFID card of a mobile telephone as a door key, then the mobile telephone can be used as a first medium. The TSM transfers the first administration information into the first SU, which is encompassed by the mobile telephone. A NFC communication connection is used when using the mobile telephone as a key for opening the hotel door, and this communication connection, apart from the primary interaction of the mobile telephone with the control module of the door lock for opening the door lock, is also used for transferring maintenance data of the door lock by way of the transfer of the second administration information. In this case, the maintenance data of the door lock is renewed via the mobile telephone, wherein this data originates from the TSM. One can therefore make do without a separate interaction between the TSM and the second SU or between the first SU and the second SU for the sole purpose of administration. In this manner, a lot of effort and thus time and/or money can be saved when administrating the second SU.

The method according to the invention can likewise be applied, for example, with a firmware change of the control module or with key change, wherein this procedure is preferably not combined with the opening of the door, but is carried out by maintenance personnel with a first medium.

The security is ensured at all times, even if the operator of the lock system (here the hotel) cannot exert a complete control over the first medium. The security results from the fact that the administration information is deposited/stored in the secure unit (for example in the SIM card in the described example) of the first medium, and, inherent of the design, cannot be read out of this without further ado.

Optionally, in the described method of the first aspect of the invention, step 3 is effected simultaneously with step 1, or step 3 is directly subsequent to step 1. In other words, the first step can be effected online, i.e. during which the communication connection exists between the first and the second medium (or of its communication modules).

In this case, the first medium to all intents and purposes serves as a connection point of a connection of the administration authority to the second medium. The administration information can thereby be transferred from the administration authority to the second medium via the detour of the first SU, without the administration information being stored in the first SU (or the administration information can only be briefly stored). The use of the first SU of the first medium can also make sense or be necessary in these embodiments, if an SU is necessary for writing and/or reading out the second medium—i.e. amongst other things, when the second medium has an SU that must be written.

As an alternative optional feature of the method, step 1 with regard to time is effected independently of step 2 and step 3. In particular, thereby step 1 is effected beforehand, i.e. the administration information is stored away in the first medium and is transferred to the second medium (service medium) at a later stage, when required and when the communication connection exists.

The method is very flexible and can be comprehensively applied due to step 1 being carried out temporally independently of step 2 and 3. The first administration information can be transferred from the administration authority to the first medium at any point in time. This can thereby be effected simultaneously with another interaction between the administration authority and the first SU and thus be advantageously combined. Analogously to this, the second administration information can be transferred from the first SU to the second medium at any point in time. This too can be effected simultaneously with another interaction between the first SU and the second medium or generally between the first medium and the second medium and as a result can, thus, be advantageously combined with this.

In both cases, the first medium—thus for example the mobile telephone—functions as a type of “relay”. The communication means of the first medium which, for example, are long-range, are used without compromising the security, due to the use of the first SU.

The first aspect of the invention, apart from the method described above, also relates to a communication system for administrating the second medium by the administration authority. The respective communication system thereby includes the administration authority (for example a TSM), a first medium and a second medium. The mentioned first medium includes a first SU and a first communication module. The second medium includes a second communication module and, for example, a second SU. The first SU is designed in a manner such that it is capable of receiving secure data in the form of first administration information, from the administration authority. The first communication module and the second communication module are designed in a manner such that they are capable of sending and receiving a signal by way of a communication connection. The first SU is designed in a manner such that it is capable of transferring second administration information based on the first administration information, via the NFC communication connection to the second medium.

In the cases, in which the second medium includes an SU (“second SU”) and the administration information relates to this, the second SU is designed in a manner such that it is capable of receiving second administration information based on the first administration information, wherein the second administration information is transferred from the first SU in the first medium to the second SU via the NFC communication connection.

Such a communication system can carry out the methods described above and therefore has the same advantages as the methods described above. This applies in each case to all possible combinations of embodiments of this method which are described as being optional. The respectively described advantages of the method are also advantages of the respective communication system implementing them.

A communication medium which, as a first medium, is capable of carrying out the previously described method likewise belongs to the first aspect. In particular, the communication medium is capable of carrying out a method with the following steps:
step 1: receiving first administration information from the administration authority and transmitting it to the first secure unit,
step 2: creating a communication connection between the first communication module encompassed by the first medium, and a communication module of a second medium,
step 3: transmitting second administration information which is derived from the first administration information, from the first secure unit to the first communication module and via the communication connection to the second communication module.

A second aspect of the invention relates to a method for the secure transfer of the data by a NFC communication connection or another wireless communication connection (for example Bluetooth, WLAN or optically via infrared radiation) from a first medium to a second medium, wherein the first and the second medium are actively operated. The second aspect of the invention also relates to a communication system for the secure transfer of data by an NFC communication connection, from a first medium to a second medium.

A multitude of different techniques are applied in the state of the art, in order to configure the transfer or transmission of data by way of such a communication connection in a manner more or less safe from unauthorised access, in particular from tapping and/or manipulation. The degree of security tends to be high or low, depending on the applied technology, wherein every technology entails specific disadvantages.

The object of the second aspect of the invention is therefore to increase the security of the transfer of data by an NFC communication connection.

The method according to the second aspect of the invention comprises the following steps:
step 1: creating a communication connection between a first communication module encompassed by the first medium, and a second communication module encompassed by the second medium,
step 2: transferring the data to be transferred, to the first SU,
step 3: encrypting the data to be transferred, in the first SU by a first key, which is stored in the first SU,
step 4: transferring the encrypted data to be transferred, from the first SU to the first communication module and transmitting the encrypted data from the first communication module to the second communication module by the communication connection.

The steps 2 and 3 can take place prior to step 1, at least partly simultaneously or subsequently to this.

The decryption of the data in the second medium can be effected in a second SU of the second medium, by a second key.

The keys, which are protected in the SU (first key, as the case may be, second key), prior to the communication method, can be written by an administration authority, for example a TSM, into the respective SUs, i.e. the method can include the prior step of transferring the first key by way of a trusted service manager TSM to the first secure unit (abbreviated SU) encompassed by the first medium, and, as the case may be, can include the transferring of the second key by the TSM to a second SU encompassed by the second medium.

The security of the secure unit in the respective medium, for example in a mobile telephone, by way of this method is used for secure communication methods other than the card emulation. This in particular can be effected for NFC communication (for example peer-to-peer NFC communication), other radio connections such as for example Bluetooth or WLAN (e.g. according to IEEE-802.11) or infrared, etc. The encrypting is delegated to the safe SU from the active communication module, which per se is not secure, such as Bluetooth or likewise. The communication module itself then does not know the key, and this key can therefore also not be obtained from the first medium (mobile telephone for example) for misuse.

Persons who set up the communication module also do not get hold of the key. The method thus permits the use of less safe communication channels for the more secure communication.

The first and the second key can be transferred in a secure manner, since the SU can be provided with the first key (and the second key as the case may be) via a trusted service, in particular a TSM. A high security is ensured due to the fact that the first (and, as the case may be, second) key never leave the respective SU, and the SU per se being well protected.

The data to be transmitted from the first medium according to the above method is transmitted, for example, in a non-encrypted manner or encrypted by way of a further key, to the first SU. In the first SU, the data to be transmitted is encrypted amid the use of the first key and is transferred to the first communication module. The first communication module transfers the encrypted data to be transmitted, to the second communication module and thus to the second medium. The encrypted data to be transmitted is decrypted in the second medium—for example in the second SU as the case may be—amid the use of the second key, and is thereafter available to the second medium in a non-encrypted manner or in a manner encrypted by a further key.

The first and the second key are thereby correlated to one another. In other words, known methods can be used for the encryption in the first SU and for the decryption. The first and the second key can be identical (symmetrical encryption) or also be different from one another, as is known per se for various wireless data transmission methods, and in particular an asymmetrical encryption is also possible. The particularity of the method lies in a particularly secure keeping of the respective keys being available to the first, and, as the case may be, to the second medium, by way of the encrypting and, as the case may be, the decrypting likewise being effected in the respective SU. This entails an additional security, in particular with the use of a first medium, which is not kept in a secure manner, in combination with communication channels which per se are less secure.

The encryption and decryption according to the method described above in particular can thereby be combined with all other methods, in order to operate and in particular to secure the communication connection. The communication can therefore be operated with a high security/safety standard, for instance with an authentication process and a first encryption according to known methods. The method according to the second aspect of the invention thus, additionally to this first encryption, additionally permits the data to be transferred to be encrypted at an even higher level, by way of the data to be transferred being yet additionally encrypted by a second encryption, thus the encryption in the first SU and the decryption in the second SU, according to the second aspect of the invention. This results in an additional security and thus fulfils the set object.

The method optionally permits the secure transfer of data by a communication connection, from the first medium to the second medium, as well as by way of analogous steps from the second medium to the first medium.

In other words, not only can the method be effected for the secure transfer of data from the first to the second medium, but also by way of suitable steps also in the other direction, i.e. bidirectionally.

As a further optional feature, the first and/or the second key includes at least two part-keys, wherein the transfer of the first key and/or of the second key by way of transferring several part-keys is effected in the prior step, which is carried out as the case may be.

The use of several part-keys for a key additionally increases the security. Moreover, the transfer of the part-keys can be effected in stages. Alternatively, a key can however also consist of a unit (thus not of part-keys) and be transferred as a unit.

The communication system according to the second aspect of the invention therefore serves for a secure transfer of data by an NFC communication connection from a first medium to a second medium and comprises a first medium and a second medium. The first medium thereby includes a first secure unit (abbreviated SU) and a first communication module. The second medium includes a second communication module and for example a second SU. The first and the second communication module are designed in a manner such that they are capable of sending and receiving data, in particular by way of a wireless communication connection (NFC, Bluetooth etc.) between the first and the second communication module. The first and, as the case may be, second SU are designed in a manner such that they are capable of storing a key in each case. The first SU is moreover designed in a manner such that on the one hand it is capable of storing a first key and on the other hand of encrypting data amid the use of this first key.

Inasmuch as the second medium includes an SU (called “second SU”), this SU is preferably designed in a manner such that on the one hand it is capable of storing a second key and on the other hand of decrypting data amid the use of this second key. As a further feature, the communication system is then designed in a manner such that data which is to be transferred from the first medium to the second medium is encrypted in the first SU amid the use of the first key, thereafter is transferred from the first communication module to the second communication module, and finally is decrypted by the second SU amid the application of the second key.

In particular, the SU(s) can be configured to receive data by a trusted service manager (abbreviated TSM), and the TSM can be used for transferring the first or second key.

Such a communication system can carry out the methods according to the second aspect, the methods being described above, and therefore has the same advantages as the methods of the second aspect which are described above. This, in each case, applies to all possible combinations of embodiments of this method, which are described as being optional. The respectively described advantages of the method are also advantages of the respective communication system that implements them.

A communication medium, which includes means as a first communication medium to carry out a method according to the second aspect, likewise belongs to the second aspect.

In particular, such a communication medium includes a communication module and an SU, and is capable of carrying out a method with the following steps:
step 1: creating the communication connection between the communication module and a communication module of another medium,
step 2: transferring the data to be transferred, to the first secure unit,
step 3: encrypting the data to be transferred, in the first secure unit, with a key stored in a secure unit,
step 4: transferring encrypted data from the first communication module to the second communication module by the communication connection.

A third aspect of the invention in particular relates to passively operated media and to write and read procedures via NFC.

It is known from the state of the art, to apply RFID tags (emulated RFID tags in mobile telephones are also counted as belonging to these) and other passively operated media for different purposes, amongst others as prepaid cards, tickets etc. Write and read procedures must thereby be carried out via a trustworthy set-up, in particular a trusted service manager. The keys, which are necessary for the write and read processes, are not permitted to be present in an insecure region, since the system is otherwise open to abuse/misuse.

However, it would be desirable if the users of access control cards, prepaid cards, ticket systems etc. were able to simply read out to data of less relevance with regard to security, such as a credit on a prepaid card, for example with a mobile phone. A need for certain write processes of security-irrelevant data directly by a user can also be present.

It is therefore the object of the third aspect of the invention, to provide a method and a system for reading and writing data from and onto media respectively, in particular passively operated media, wherein this method and system permit users to have a simpler access to certain data.

This object is achieved by a method for carrying out a write and/or read process, onto and from a passively operated second medium respectively, amid the use of a first, actively operated medium, wherein the first medium includes a secure unit (GU), with the following steps:
providing a write and/or read applet in the secure unit,
providing an application outside the secure unit,
transferring the write and/or read command by the application onto the applet,
converting the write and/or read command into a write and/or read signal by the applet, and
transferring the write and/or read signal onto the passively operated second medium.

The write and/or read signal corresponds to the standard, according to which the second medium is operated; for example, it can be designed according to a standard (e.g. ISO 14443). In this medium, it activates the write process or is at the beginning of a data exchange, in which the desired data to be read is transferred to the first medium. The implementation of the write and/or read process on account of the write and/or read signal in the passively operated second medium or between the first and the second medium is therefore effected as is known per se and is not explained further here.

An “applet” here is generally to be understood as a program or program part, which serves an application program (an application) for carrying out one or more specific tasks. The term “applet” is thus not to be understood as being limited to a certain programming language.

The application in particular can be installed in the first medium, but possibly also outside the secure unit. Alternatively, it can also be installed outside the first medium and can directly activate the applet—via a communication module of the first medium.

The second medium can be a medium, which is external in relation to the first medium, for example an RFID tag. The transfer of the write and/or read signal then contains the part-steps of transferring the write and/or read signal to a communication module of the first medium and transferring the write and/or read signal by the communication module to the second medium.

Alternatively, the second medium can also only be functionally different to the first medium, for example by way of it being an RFID card that is emulated by the secure unit of the first medium. In this case, the transfer of the write and/or read signals to the second medium is then a process in the inside the SU.

Due to this procedure, it is now possible for security-irrelevant data such as a credit stored on the second medium, for example, to be able read out by the user, for example by his mobile telephone. If the prepaid card is a physical prepaid card (in particular in the form of an RFID tag), the user for this purpose merely needs to hold the prepaid card onto his mobile telephone and carry out the application concerned, whereupon the mobile telephone can display the credit. If the second medium is a medium emulated in the secure unit (for example on the SIM card) then the read-out process can take place at any time by way of the respective application. A significant gain in comfort for the user results from this, and possible incorrect entries and similar things are immediately recognisable. This analogously also applies to applications other than as prepaid cards and for security-irrelevant write processes.

The security of the system is not compromised, despite this additional access to the user and the gain in comfort resulting from this. The keys for write and read processes remain stored in the inside of the SU, and are only available to the applet (and not to the application itself) and are never given out. The applet—which is secure from manipulation since it is present in the SU—can be programmed such that it only accepts commands for security-irrelevant write or read processes. Optionally, one can also envisage such processes of different security stages being made dependent on an authentication of the application with respect to the applet. The non-critical processes can therefore be carried out by way of an application, which is stored in the non-secure region of the mobile telephone (and can therefore be basically manipulated for misuse), whereas the authentication of a trustworthy authority with respect to the applet is demanded for processes which or more relevant concerning security.

The applet itself is not accessible to manipulation, since it is stored in the secure unit.

The third aspect also relates to a communication medium with a secure unit and with a communication module, with which an applet is installed in the secure unit and which is capable of carrying out the method according to the third aspect. In particular, the communication medium is capable of carrying out the following method:
transferring a write and/or read command of an application to the applet,
converting the write and/or read command into a write and/or read signal by the applet, and
transferring the write and/or read signal to a passively operated second medium.

The third aspect relates to a system that is configured to carry out this method and, apart from the communication medium, also includes a passively operable second medium as well as the application (on the first medium or running externally).

First applications of the system and of the method are the mentioned reading-out of security-irrelevant data from the second medium by the user.

A further possible application is the delegation of access rights from one user to the other. With this application—and further comparable applications—the applet will (also) carry out a write process. For example, it can be rendered possible for the user with access to a hotel room to copy his electronic room key onto a (physically or emulated) RFID tag of another person, so that he himself also has a room key—of course with the same temporal limitations as the first person himself.

Similarly, one can also envisage the transfer of smaller credits or tickets from one user to the other.

A further case of application can be the discrete generation of access cards (for example electronic hotel room keys) by way of the first medium. For example, an already registered guest who has reserved his room, can demand such an electronic key in a manner activated automatically or manually, and this key is then made available by the electronic booking system of the hotel (after a successful authentication, corresponding to the standards of the hotel) and is written by the mobile telephone of the user directly onto the physical or virtual (emulated in the mobile telephone) RFID tag, with the method according to the invention.

Other applications within the scope of the hotel are also conceivable, for example payments that are limited with regard to the amount, for example the charging of the room bill according to restaurant consumption, by way of writing directly onto the RFID tag (room key).

A fourth aspect of the invention relates to an improved NFC communication connection between the first (active) medium and a second, passively operated medium.

A medium is thereby firstly to be understood as an electronic device (hardware), which includes data processing means. The data processing means can thereby be designed as software and/or as at least a part of the electronic apparatus. Secondly, a medium can also be an emulated medium, i.e. an entity that simulates characteristics of an electronic apparatus by way of a computation system.

The state of the art has the disadvantage that the NFC communication connection has an inadequate quality in certain situations. This, for example, is the case due to characteristics of the medium that are inherent of the construction type (small induction loop) or due to a selected operating mode (for example, with a mobile telephone with an emulated RFID card when the mobile telephone is switched off). A spatial alignment of the emitting and/or receiving device or a large distance or a changing distance between the media can compromise the quality of the NFC communication connection. In particular, the quality of the NFC communication connection can also reduce, and the NFC communication connection can break down on account of this.

It is therefore the object of the fourth aspect of the invention, to provide a method and a device (communication medium) of the initially mentioned type, which improves the quality of the NFC communication connection.

According to the fourth aspect, a method for operating an NFC communication connection between a first medium and a second medium is provided, wherein the first medium is actively operated and the second medium is passively operated (i.e. is a passive medium or is a medium, which per se is capable of active operation, being operated in the card emulation mode), wherein the method includes the sending of an enquiry signal from the first to the second medium. The invention according to the fourth aspect is now characterised in that an emitting power, with which the enquiry signal is sent, is selected adaptively in dependence on a parameter characteristic of the communication.

The term “enquiry signal” and “response signal” are not to be understood in that the built-up communication (necessarily) consists of an enquiry and response. In contrast, the enquiry signal is generally emitted with the framework of the build-up of communication connection, wherein it provides the necessary energy for the second, passively operated medium. Within the framework of a read-out process, it triggers a response signal and/or a write process in the second medium, and such a communication connection can be built up, for example, in the manner known per se according to ISO 14443. A response signal for example can consist of a load modulation or be sent back in the form of modulated back-scatter.

These parameters can, for example, be the signal quality of the response signal. In this first group of embodiments, the method thus includes the steps:
step 1: sending an enquiry signal from the first medium to the second medium, and receiving a response signal which is sent by the second medium as a reaction thereto, by the first medium,
step 2: evaluating a signal quality of the response signal by the first medium,
step 3: controlling an emitting power of the enquiry signal of the first medium in dependence on step 2, wherein a signal power of the enquiry signal is increased if, in step 2, it is ascertained that the response signal is an NFC signal of insufficient signal quantity.

The parameter according to a second group of embodiments can also consist of information (or at least contain such information), as to whether a read or a write process is to be activated. Inasmuch as the second medium is to be written, the emitting power is selected higher than if only a read process is to take place.

According to a third group of embodiments of the fourth aspect, the characteristic parameter can also lie in the identification of the second medium or at least include such. A passive medium in the framework of the communication can be identified by the active medium by way of an ID and be simply assigned to a certain technology. If for example, after the communication connection has been built up, at the beginning, it is ascertained that the second medium is a mobile telephone operated in the card emulation mode, the emitting power is then selected higher than if it were to be the case of a conventional RFID tag.

Combinations of these possibilities are conceivable without further ado, for example the selection of the emitting power in dependence on the signal quality as well as on whether a read or write process is to take place, the selection of the emitting power in dependence on the signal quality as well as on the type of the second medium, the selection of the emitting power in dependence on whether a read or a write process is to be carried out, as well as in dependence on the type of medium, or a combination of all three possibilities.

With examples of embodiments of the first group (as the case may be, combined with the second and/or third group), the evaluation of the signal quality, for example, can include the evaluation a measurable variable of the received signal, for example of an amplitude and/or frequency (and/or their change) of the received electromagnetic radiation for instance, or the testing of a presence of a control signal or of the agreement of a test variable. Likewise possible is the measurement of a number of transmitted information units such as bits or a ratio of the signal magnitude to a defined threshold, for example to a threshold value, or another suitable test. A further, often particularly favourable possibility is the determining of bit errors by way of a check-sum test (or likewise).

With suitably selected defined signal characteristics, a low/insufficient quality of the NFC communication connection can be deduced as soon as the evaluation shows that which is received, although being an NFC signal, is however of an insufficient signal quality (for example, by way of it having bit errors or only a part of a message having been received (premature abort)). The first medium changes the emitting power of the emitted NFC signal from a first emitting power to a second, higher emitting power as a reaction to the determined low quality of the NFC communication connection.

After a defined duration and/or after a completed process (for example, the completion of the authentication), the first medium changes the emitting power back again to the first, lower emitting power, in order to save energy, or it goes directly into a standby mode (idle condition or polling operation; period emitting of short signal pulses for determining as to whether a passively operated medium is in range).

Such a defined duration, as the case may be, can thereby be directed to an average duration of a NFC communication connection, for example for a defined process of a uniform length, for instance of an authorisation for door opening or likewise. The defined duration however can also be selected such that a time interval which is deliberately kept short necessitates a plurality of emitting power changes, in order to permit a data transfer.

Such a defined duration can lie in the range of 0.3 to 30 seconds, in particular in a range of 0.5 to 15 seconds. The duration can be selected such that a quality improvement of the NFC communication connection and an energy-saving operation of the first medium are simultaneously rendered possible.

The procedure according to the fourth aspect is particularly advantageous for the following case: For battery-operated first media, which, for example, are installed in locks or mobile devices, the emitting power is minimised, in order to take due consideration of the battery consumption. This functions well in combination with passive RFID cards, and likewise quite well for Java cards and mobile telephones in card emulation mode, when these devices are active and supplied by battery. Although the read-out process still functions if the mobile telephone is switched off or the battery is empty, however its functions very poorly since the received power must also serve for ensuring certain basic functions of the chip (generally of a secure element (SE), often of the SIM card of the mobile telephone) emulating the RFID card. The range then becomes extremely short. For such a case, one envisages the emitting power of the enquiry signal increasing by way of procedure according to the fourth aspect of the invention.

The advantage of this fourth aspect is therefore the fact that the quality of the NFC communication connection is improved, but simultaneously no excessively large energy consumption results. Typically, batteries (accumulators or non-rechargeable batteries) are used as energy sources in media and these have a limited storage capability. The energy that is present should be applied as sparingly a possible for this reason. The method, which is described above, permits the existing energy to be applied in an optimal manner, by way of a high emitting power only being applied when needed. The increased consumption by way of the second, increased emitting power is moderate in comparison to the consumption from the permanent operation (periodic emitting pulses, as the case may be real-time clock). Because a greater part of the existing energy is typically consumed in the first medium in the idle condition (standby mode), a brief increase in the emitting power in the active condition is of little consequence in comparison to this. The cycle, with which the batteries must be exchanged, for example in locks, is not shorter or is only insignificantly shorter.

The first medium in the idle condition for example periodically emits signal pulses with a lower emitting power, in order to ascertain whether a second medium is located in the communication region (medium in the field). If this is the case, the first medium emits an enquiry signal. If the received response signal is a perfectly readable NFC signal, then this operation is continued until the read-out process is completed. If the received response signal although being recognisable as a NFC signal, however is inadequate (for example, if bit errors are ascertained) then the emitting power is increased. If the received response signal is not recognised as an NFC signal, then the first medium for example goes back into standby operation and again emits periodic signal pulses.

The fourth aspect of the invention thus also relates to an actively operable NFC apparatus, i.e. an NFC communication medium for carrying out the described method. The method includes a communication module, and is capable of permitting the communication module to emit an NFC enquiry signal with an adaptively selectable power, i.e. with at least a first and a second, high emitting power.

The NFC communication medium, for example, can be capable of sending an enquiry signal to a second medium and of receiving a response signal, which is sent by the second medium as a reaction thereto, by the first medium (3), of evaluating a signal quality of the response signal and of controlling an emitting power of the enquiry signal in dependence on the results of this evaluation.

For this purpose, the communication medium can include a control unit that controls the power.

The described device permits the application of the method of the fourth aspect, which is described above. As a result, the device also has the advantages described above. Moreover, the device can also include the optional features mentioned above, wherein these entail the advantages described above.

Further preferred embodiments are to be deduced from the dependent patent claims. Thereby, features of the method claims with regard to context can be combined with the device claims and vice versa.

Features of the different aspects of the invention with regard to context can be combined amongst one another, i.e. the fourth aspect, for example, can be combined with the first aspect, e.g. by way of using a service medium, which is configured according to the fourth aspect, in a method according to the first aspect, and combinations of both aspects together or in each case alone with the second aspect are conceivable. Combinations of all aspects and of mentioned combinations of aspects with the third aspect are further conceivable.

Uses, on the one hand in the fields of security of premises and room access authorisation apply to all aspects and embodiments, in private buildings as well as semi-public buildings—for example hotels; the issuing of hotel keys, etc. Moreover, there are also uses in ticketing (ticket control and/or ticket invalidation, charging an electronic ticket onto a mobile communication medium, in the field of prepaid card systems, but also in direct communication between mobile apparatus, for example for the exchange of personal information such as addresses, for synchronisation etc.).

Apart from communication media, software which enables communication media to carry out the methods described here likewise belongs to the invention.

### BRIEF DESCRIPTION OF THE DRAWINGS

The subject-matter of the invention is explained in more detail hereinafter by way of preferred embodiment examples which are represented in the accompanying drawings. In each case in a schematic manner are shown in:

FIG. 1 is a device for the improvement of quality of a NFC communication connection according to the fourth aspect of the invention;

FIG. 2 is a procedural diagram of the method according to the fourth aspect;

FIG. 3 is a communication system for administrating the second SU of the second medium by a TSM, according to the first aspect of the invention;

FIG. 4 is a communication system for the secure transfer of data by a NFC communication connection, from a first medium to a second medium, according to a second aspect of the invention; and

FIG. 5-7, in each case, a communication system according to the third aspect.

### DETAILED DESCRIPTION OF THE INVENTION

The reference numerals used in the drawings and their significance are listed conclusively in the list of reference numerals. Basically, the same parts are provided with the same reference numerals in the figures.

FIG. 1 shows an active NFC communication medium 3 for carrying out the method according to the fourth aspect. The communication medium 3 comprises a communication module 1 and a control unit 2 (which here is drawn separately, but can however also be realised integrated in the communication module). The communication medium can be integrated, for example, into the control of the mechatronic elements of a door lock, represent a read/write device for prepaid cards, be capable of ticket control and/or ticket invalidation, for charging an electronic ticket onto a mobile communication medium, or be any other device for the communication by way of NFC.

FIG. 1 also shows a passively operated second medium 10, which can be designed, for example, as a passive RFID chip or however as a mobile telephone. A passive operation (card emulation module) can also be possible in cases in which the mobile telephone per se is capable of active NFC communication. The second medium independently of its physical nature will have a function which is adapted to the design of the apparatus. For example, with the application of “access control” the (the device is integrated as a control module into the door lock), the second medium, for example, can have the function of a passive chip card which is used as a door key.

“Passive” in this context is to be understood in that the respective apparatus does not need to muster any power for the NFC communication, but can be read out and, under certain circumstances, also be written. The passive NFC communication partner in this function is also indicated as a transponder if it obtains energy from the active NFC communication partner in the manner described above.

The communication module 1 in the first medium (NFC communication medium 3) is capable of sending an enquiry signal to a second, passive medium and moreover, if required can also be configured to carry out write processes by way of NFC signals (the ability of being able to commute in a peer-to-peer mode and which is not central in this fourth aspect, can of course also be set up).

Moreover, the communication module 1 is capable of emitting an NFC at a first emitting power (L=1) or at a second emitting power (L=2).

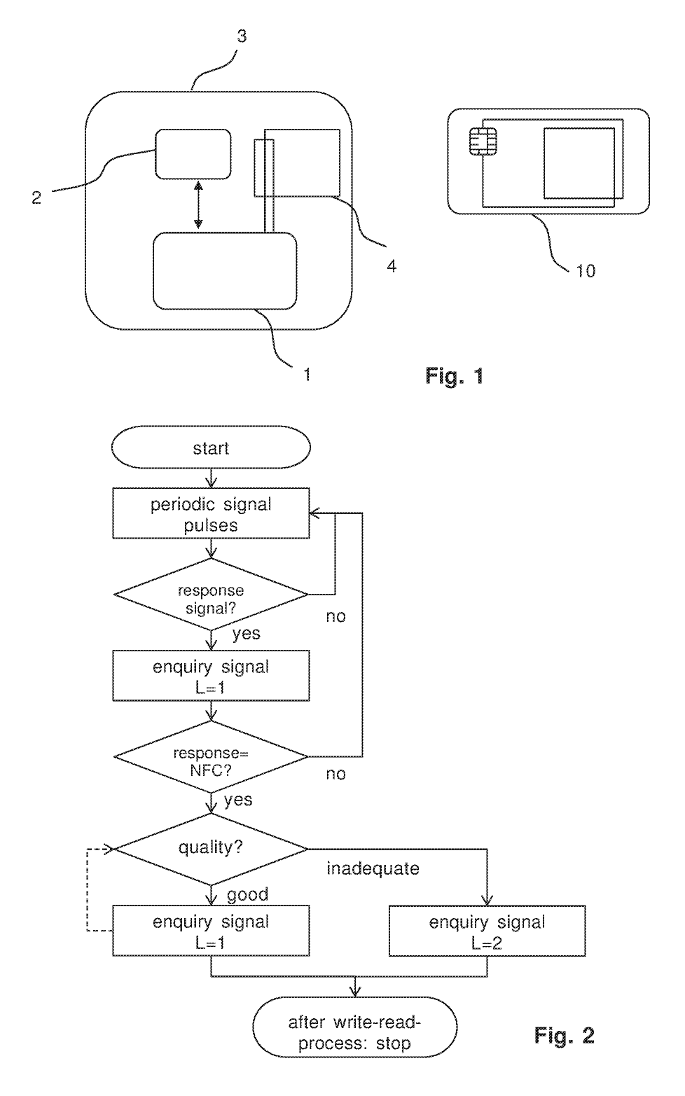

FIG. 2 shows an exemplary procedural diagram of a method of the type according to the invention. In a standby mode with low energy consumption, the communication module for example regularly sends short enquiry pulses, in order to ascertain whether an NFC medium is present in the reception region.

Inasmuch as a response signal, which can be interpreted as a response signal of a NFC medium, is ascertained, the communication module is completely awoken and sends an enquiry signal at the normal first emitting power (L=1). Inasmuch as the response signal can be interpreted as an NFC signal, (if not, the first medium, for example, goes back into the standby mode), according to the invention, the signal quality is evaluated.

For this purpose, the control unit 2 is capable of applying defined criteria on the NFC signal received by the communication module 1. For example, it can be determined by way of a check-sum test, as to whether and, as the case may be, how many bit errors are made on transmission. The quality is classified as being insufficient if too many bit errors are determined.

Inasmuch as the signal quality is sufficient, the enquiry signal continues to be emitted at the first emitting power, until the desired process is completed (“stop”), whereupon the system, for example, returns back into the standby mode (“periodic signal pulses”). If not, the emitting power of the enquiry signal is set to the second, higher level (L=2) and the process is carried out at this, until it is finished (“stop”). In this case too, the system can return into the standby mode after completion of the process.

One can also envisage the second emitting power to only be retained during a defined time, and thereafter returning back to the first emitting power (inasmuch as the process is still not completed and/or the second medium remains in the reception region).

Complementarily or alternatively, one can envisage a signal quality control being carried out permanently during the read process or write and read process or at least as long as the system emits at the first emitting power (dashed arrow).

The first emitting power as a rule is sufficient, in order to communicate with possible NFC communication partners in the normal reception range of the communication module 1 of maximally about 10 cm. The second emitting power is different to the first emitting power and is significantly greater than normal emitting powers, for example by at least 50% higher and for example at least double as high. The enquiry signals, with the first as well as the second emitting power are at a signal frequency, which is defined by standard, for example 13.56 MHz.

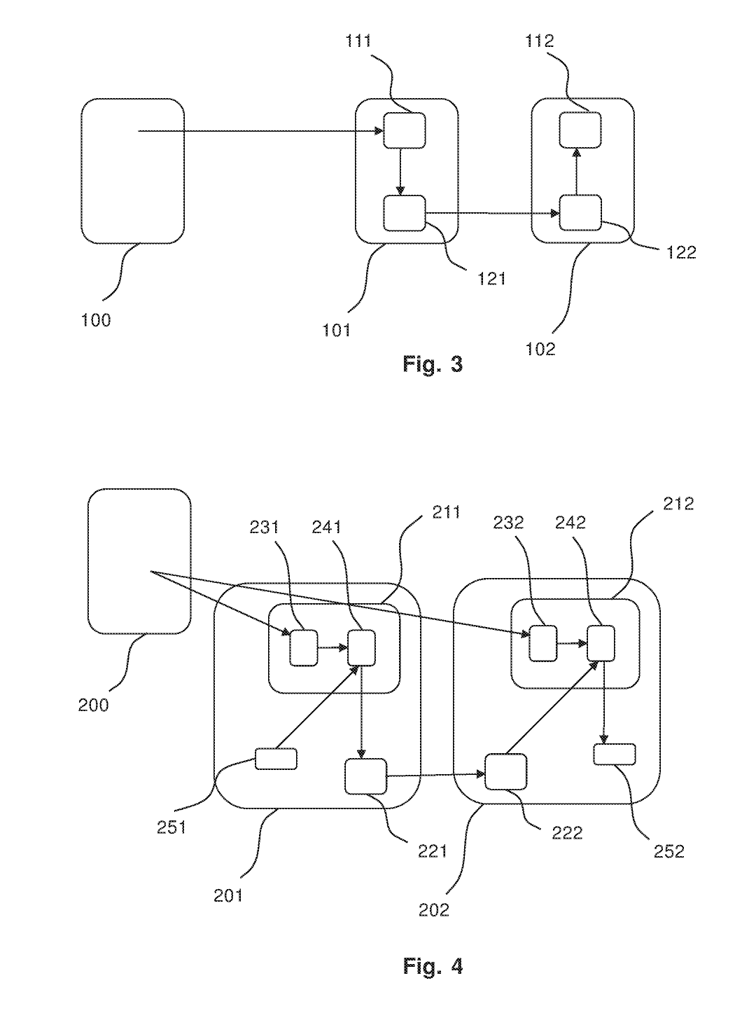

FIG. 3 shows a communication system for administrating a second medium 102 by way of a TSM 100 according to the first aspect of the invention. The second medium 102 comprises a second communication module 122 as well as a second SU 112. The communication system apart from the TSM 100 and the second medium 102 yet includes a first medium 101. The first medium 101 includes a first SU 111 and a first communication module 121.

The aim of the embodiment described here, of the method according to the first aspect, the method here being used on a device according to the first aspect, is to update firmware of the second SU 112 which is provided by the TSM (updating firmware). For this, the TSM transfers first administration information to the first SU 111 and thus to the first medium 101. The first administration information is stored in the first SU 111. This first administration information on the one hand includes the new firmware version for the second SU 112, as well as information for the first SU 111 concerning the fact that this new firmware information is envisaged for the second SU 112. Moreover, the first administration information includes an indication to the first SU 111, that the first administration information is to be deleted in the first SU, after a transfer of the new firmware version to the second SU 112.

Inasmuch as the first communication module 121 assumes an NFC communication connection to a communication partner, an identification of the communication partner is examined by the first SU. If, with regard to the communication partner, it is the case of the second medium 102, which includes the second SU 112, for which the new firmware version is envisaged, then the first SU 111 transfers second administration information to the first communication module 121. The first communication module 121 transfers this second administration information to the second communication module 122, which in turn transfers the second administration information to the second SU 112. The second administration information includes the new firmware version as well as an indication for the installation of this in the second SU 112. The first SU 111 deletes this first administration information, after the transfer of the new firmware version in the second administration information to the second SU 112. The new firmware version gets from the TSM into the second SU 112 and is also installed there, in this manner.

Updates of the firmware from other components of the second medium (or of a second medium without SU) can be carried out in an analogous manner, where then the last step “transferring the administration data to the second SU” is replaced by the transfer to the respective components, which is to say is completely done away with, given an update of the second communication module.

FIG. 4 shows a communication system according to the second aspect of the invention and serves for a secure transfer of data by a communication connection, from a first medium 201 to a second medium 202. This communication medium permits the application of the method of the second aspect of the invention. The communication system includes a first medium 201 and a second medium 202. The first medium 201 includes a first secure unit (abbreviated SU) 211 and a first communication module 221. The second medium 202 includes a second SU 212 and a second communication module 222.

The first communication module 221 and the second communication module 222 are designed in a manner such that they are capable of sending and receiving data by way of a peer-to-peer NFC communication connection (in the example described here; it can be also conferred upon other communication connections such as Bluetooth, other NFC communication connections etc., without further ado) between the first communication module 221 and the second communication module 222. The first SU 211 and the second SU 212 are designed in a manner such that they are capable of receiving data by a trusted service manager 200 (abbreviated TSM).

The first SU 211 is thereby capable of receiving a first key 231 from the TSM 200 by way of a mobile telephone network. The second SU 212, analogously to this, is thereby capable of receiving a second key 232 from the TSM 200 by way of a mobile telephone network. The first key 231 and the second key 232 are stored in the respective SU 211, 212 after being received.

The first SU is moreover designed in a manner such that it is capable of encrypting data amid the use of this first key 231. The encryption of the data is thereby effected in a first processor 241, which is encompassed by the first SU 211. And the second SU is designed in a manner such that it is capable of decrypting data amid the use of the second key 232. The decryption of data is thereby effected in a second processor 242, which is encompassed by the second SU 212.

The described communication system is designed in a manner such that data, which is to be transferred from the first medium 201 to the second medium 202, is made available to the first medium 201 as start information 251. After the data to be transferred has been securely transferred to the second medium 202, the data is available to the second medium 202 as target information 252. This is effected by way of applying the method according to the second aspect of the invention.

Prior to this, for example with a one-off initialisation process, the TSM 200 transfers the first key 231 to the first SU 211, and the second key 232 to the second SU 212.

The system is ready for a secure data transfer as soon as a NFC communication connection exists between the first communication module 221 and the second communication module 222. The NFC communication connection is thereby already encrypted by a first encryption, for example according to a procedure known per se.

The data in the start information 251 is now to be transferred securely from the first medium 201 to the second medium 202. For this, the data 251 to be transferred is transferred into the first SU 211 and onto the first processor 241. The first processor 241 encrypts this data 251 amid the use of the first key 231. The first microprocessor 241 then transfers the encrypted data to the first communication module 221, which transfers this via the NFC communication connection to the second communication module 222 and thus to the second medium.

The second communication module 222 thereafter transfers the encrypted data onto the second processor 242. The second processor 242 decrypts the encrypted data amid the use of the second key 232. The decrypted data is transferred from the second processor 242 onto a region of the second medium 202 outside the second SU 212 and there is made available to the second medium as decrypted data 252, for example in a non-encrypted manner. A content of the data 251 in the first medium 201 and which is to be transferred, in this manner gets into the second medium 202 in a particularly secure manner, to which second medium it is then available as target information 252. Even if data were to be taken from the secure NFC communication connection due to manipulation, this data is, however, still additionally encrypted and therefore more secure by an additional stage.

The first key 231 and the second key 232 never leave their respective SU 211, 212 and are therefore well protected, which increases the security of the transfer of the data to be transferred. The first key 231 and the second key 232 are thereby functionally related, which is defined by the applied encrypting and decrypting methods.

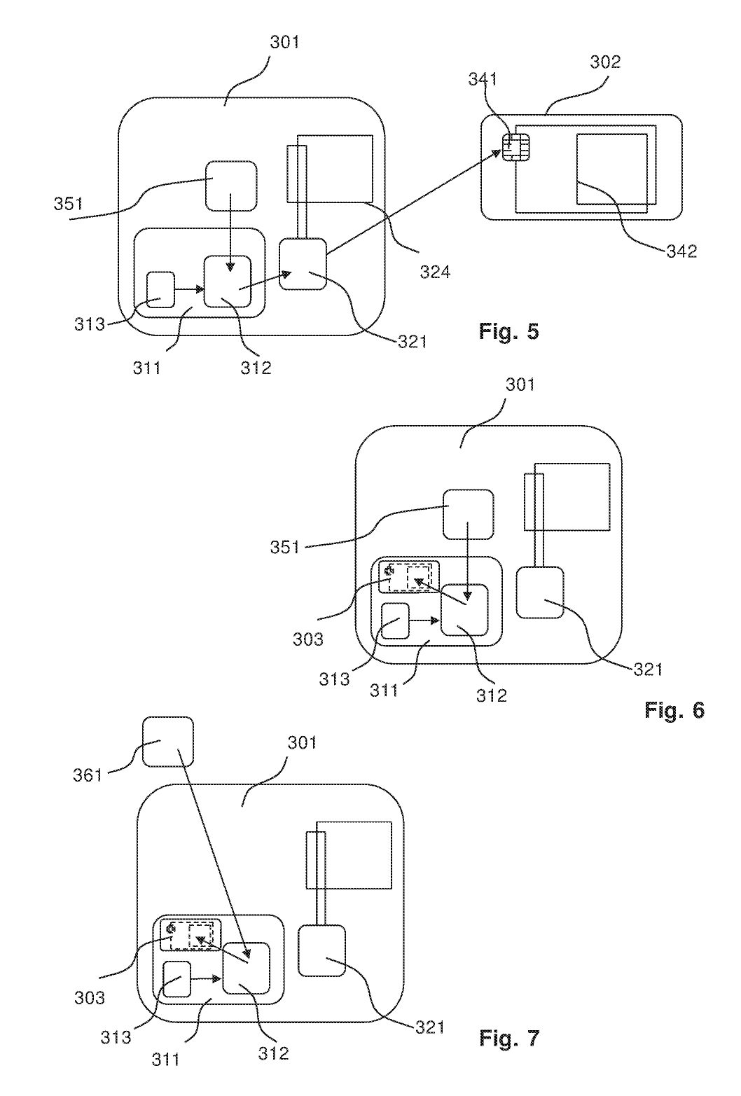

A possibility for implementing the third aspect of the invention is described by way of FIG. 5. The first medium 301 includes an SU 311 and a communication module 321, which is capable of communicating with further media via a radio connection, in particular via NFC (an associated antenna 324 is schematically represented in FIG. 5). The SU 311 in FIG. 5 includes processor and memory means, which are not represented, and by way of which, amongst other things, an applet 312 is implemented. This accepts write and/or read commands from an application 351, which is arranged outside the SU. The applet can produce a write and/or read signal amid the use of a key 313, which is likewise available only within the SU 311, wherein the applet transfers this signal further to the communication module 321.

FIG. 5 also shows a second medium 302, which here is a purely passive RFID card. The (external with respect to the first medium) second medium can also be capable of active operation, which in the method described here is passively operated.

The second medium includes a chip 341, in which a processor and memory means are applied; an RFID antenna 342 is also schematically illustrated in FIG. 5.

The method described here now envisages the write and/or read signal, which is produced by the applet being transferred by the communication module 321 to the second medium and there activating the desired write and/or read process. The signal transfer can be effected physically by way of load modulation, for example.

FIG. 6 shows a variant, with which the method take its course in an analogous manner, wherein the second medium 303 however is a medium that is emulated in the SU 311 and not a physical medium. The applet 312, which is activated by the application 321, therefore acts upon the second medium 303 emulated in the SU 311, for the write and/or read process. The communication module 321 is not required for the method and is optional, wherein despite this it is generally present, for example for applications, in which the first medium 303 communicates to the outside.

The variant according to FIG. 7 differs in that the application 361, which wishes to carry out the write and/or read process, does not run on the first medium, but externally. The application can, for example, run on another medium, for example on a mobile medium (mobile telephone, laptop, tablet computer etc.), on a desktop computer, a server, for example of a central unit, etc. The communication with the first medium can take place via the communication module 321 or via another channel in a wireless manner or with contact. There are many respective possibilities.

A combination of the concepts of FIG. 7 and FIG. 5 is also conceivable, i.e. the communication of an external application with a physical, second medium via the applet.

In the embodiment examples of the different aspects of the invention, the involved, actively operated media in particular can be battery operated (standalone solutions). This applies to the mobile devices (mobile telephones; a battery is the standard energy source with these), as well as with the service media, for example installed in locks. The different aspects of the invention in particular are well suited to such standalone service media, since they provide suitable solutions for their specific problems.

1-33. (canceled)

34. A method for the secure transfer of data to be transmitted, by a communication connection, from a first actively operated medium with a first secure unit to a second actively operated medium, comprising the following steps:
step 1: creating a communication connection between a first communication module encompassed by the first medium, and a second communication module encompassed by the second medium,
step 2: transferring the data to be transferred, to the first secure unit,
step 3: encrypting the data to be transferred, in the first secure unit by a first key, which is stored in the secure unit,
step 4: transferring the encrypted data from the first communication module to the second communication module by the communication connection.

35. The method according to claim 34, wherein steps 2 and 3 take place prior to step 1.

36. The method according to claim 34, wherein steps 2 and 3 take place at least partly simultaneously to step 1.

37. The method according to claim 34, wherein steps 2 and 3 take place subsequently to step 1.

38. The method according to claim 34, wherein decryption of the data in the second medium is effected in a second secure unit of the second medium, by a second key.

39. The method according to claim 34, wherein in an initialisation step before step 1, the first key and/or a second key of a second secure unit of the second medium is written by a trusted service manager onto the first and second secure unit respectively.

40. The method according to claim 39, wherein in the initialisation step before step 1, the first key and/or a second key of a second secure unit of the second medium is written by a trusted service manager onto the first and second secure unit respectively, wherein the first or second key comprises at least two part-keys, which are written separately.

41. The method according to claim 34, wherein the method permits the secure transfer of data by way of the communication connection, from the first medium to the second medium, as well as by analogous steps from the second medium to the first medium.

42. The method according claim 34, wherein the communication connection is an NFC connection, a Bluetooth communication connection, a WLAN communication connection, a communication connection via an infrared interface, or a wire-connected communication connection.

43. A communication connection with a secure unit, wherein the communication medium comprises means as a first medium to carry out a method according to claim 34.

44. A communication system for the secure transfer of data by a communication connection, from a first medium to a second medium, comprising a first medium and a second medium, wherein
the first medium comprises a first secure unit and a first communication module,
the second medium comprises a second communication module, and
the first communication module and the second communication module are designed such that they are capable of sending and receiving data by a communication connection between the first communication module and the second communication module,
wherein
the first secure unit is designed such that on one hand it is capable of storing a first key and on the other hand of encrypting data amid the use of this first key and
that the communication system is designed such that data to be transferred from the first medium to the second medium is encrypted in the first secure unit amid the use of the first key and thereafter is transferred from the first communication module to the second communication module.

45. The communication system according to claim 44, wherein the second medium comprises a second secure unit with a second key, wherein the second secure unit is designed such that it is capable of decrypting the data received from the first medium, amid the use of this second key.

46. The communication system according to claim 44, wherein the secure unit is configured to receive data by a trusted service manager, and the trusted service manager can be used for transferring the first key or second key.

47. The communication system according to claim 46, wherein the secure unit is configured to receive data by a trusted service manager, and the trusted service manager can be used for transferring the first key or second key.
